(19) United States
(12) Patent Application Publication
(10) Pub. No.: US 2023/0227118 A1
(43) Pub. Date: Jul. 20, 2023

(54) Vertical Bicycle Rack with Adjustable Tire Cradle

(71) Applicant: Kuat Innovations LLC, Springfield, MO (US)

(72) Inventor: Jordan Bowles, Springfield, MO (US)

(73) Assignee: Kuat Innovations LLC, Springfield, MO (US)

(21) Appl. No.: 18/150,575

(22) Filed: Jan. 5, 2023

Related U.S. Application Data
(60) Provisional application No. 63/300,079, filed on Jan. 17, 2022.

(51) Int. Cl. B62H 3/10

(52) U.S. Cl. CPC B62H 3/10

(57) ABSTRACT

A vertical bicycle rack is described with an adjustable tire cradle to provide optimal support to bicycles having different widths of tires. The adjustable tire cradle has two tire retention members that may be moved with respect to one another to change the distance between them to match a desired tire size. The adjustable cradle reduces movement of a bicycle tire in the cradle during use and reduces movement of and damage to bicycles stored in the rack. The tire retention members may be attached to the bicycle rack by separate brackets, one of which may be movable. The tire retention members may also be supported on the same bracket provided with a mechanism for moving one or both of the tire retention members to alter the distance between them.

### CROSS-REFERENCE TO RELATED APPLICATIONS

This application claims the benefit of U.S. Patent Application Ser. No. 63/300,079 filed Jan. 17, 2022, the disclosure of which is incorporated herein by reference.

### BACKGROUND

### Field of the Invention

This disclosure is in the field of bicycle racks. More specifically, this disclosure is in the field of bicycle racks configured to support bicycles in a vertical orientation.

### Description of the Related Art

Vertical bicycle racks support bicycles in a vertical orientation and may be used, for example, for transporting bicycles on a vehicle or to store bicycles in a fixed location. Many of these vertical bicycle racks are provided with an upper crossbar that supports the front tire or front fork of a bicycle in a position vertically above the back tire. Contact between the rack and the bicycle fork or other parts of the bicycle frame are undesirable because the contact may result in damage to the bicycle frame or a component of the bicycle. It is preferable to minimize contact between the bicycle frame or other components and to maximize the use of tire contact to provide support to the bicycle.

In some of these racks one or more tire cradles are attached to the upper crossbar to receive the front tire of the bicycle. The cradles are typically fixed hoops or cradles that do not adjust. A user may need to utilize a vertical bicycle rack to store different bicycles with different size tires, especially tires with different widths. The known tire cradles do not provide optimal support to tires whose width is wider or narrower than the nominal width of the cradle. The extra space between the tire and the cradle may result in movement of the tire within the cradle during use of the vertical bicycle rack, especially during transport on a vehicle. Damage to the bicycle tire or wheel may result from unwanted movement or forces arising from an imprecise fit between the tire cradle and the bicycle tire.

### SUMMARY OF THE INVENTION

In various embodiments, the inventive adjustable tire cradle comprises a tire cradle for a vertical bicycle rack with an adjustable width. In varying embodiments, the adjustable tire cradle may have a fixed bracket and a movable bracket with each bracket supporting a tire retention member. In such embodiments the movable bracket may be moved with respect to the fixed bracket to adjust the distance between the tire retention members to accommodate various widths of bicycle tires.

In other embodiments of the adjustable tire cradle, a single bracket may be used to support both tire retention members. In these embodiments, one or both of the tire retention members may move with respect to the bracket to adjust for the width of the bicycle tire.

### BRIEF DESCRIPTION OF THE DRAWINGS

FIG. 1A is a perspective view of a prior art vertical bicycle rack

FIG. 1B is a detailed view of an embodiment of the inventive bicycle rack with an adjustable tire cradle with a bicycle tire disposed therein.

FIG. 1C is a detailed side view of an embodiment of the inventive bicycle rack with an adjustable tire cradle in a first configuration.

FIG. 1D is a detailed side view of an embodiment of the inventive bicycle rack with an adjustable tire cradle in a second configuration.

FIG. 1E is a detail top view of part of an embodiment of the inventive bicycle rack with an adjustable tire cradle.

FIG. 1F is a detail perspective view of part of an embodiment of the inventive bicycle rack with an adjustable tire cradle.

FIG. 2A is a partial perspective view of an embodiment of the inventive bicycle rack with a horizontal translation mechanism in a closed position.

FIG. 2B is a partial perspective view of an embodiment of the inventive bicycle rack with a horizontal translation mechanism in an open position.

FIG. 2C is a perspective view of an embodiment of the inventive bicycle rack.

FIG. 3A is a partial schematic side view of an additional embodiment of the inventive bicycle rack.

FIG. 3B is a partial schematic side view of an additional embodiment of the inventive bicycle rack.

FIG. 4A is a partial perspective view of an embodiment of the inventive bicycle rack.

FIG. 4B is a partial side view of an embodiment of the inventive bicycle rack.

FIG. 4C is a partial end view of an embodiment of the inventive bicycle rack.

FIG. 4D is a partial top view of an embodiment of the inventive bicycle rack.

FIG. 4E is a partial bottom view of an embodiment of the inventive bicycle rack.

### DETAILED DESCRIPTION

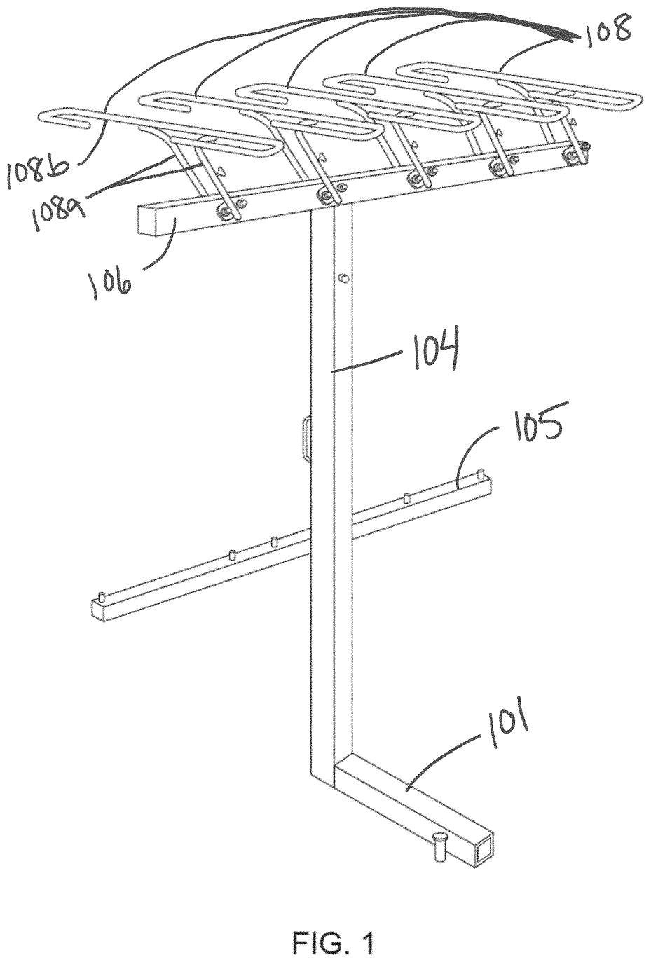

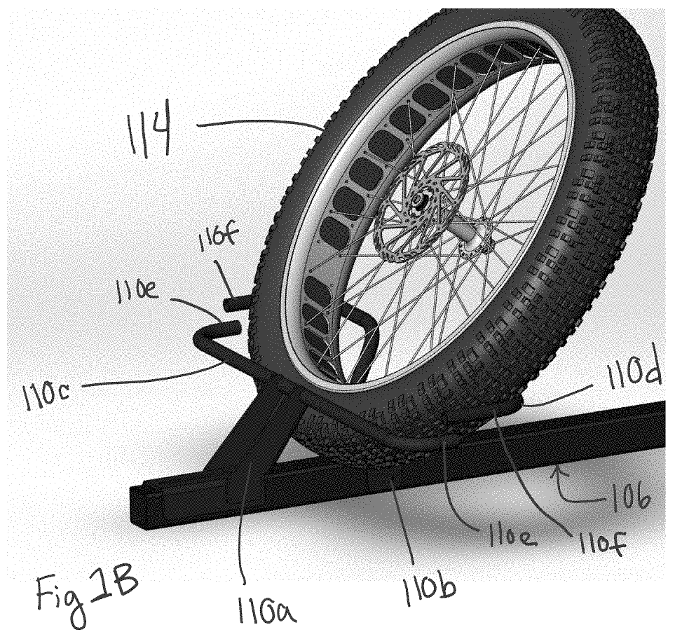

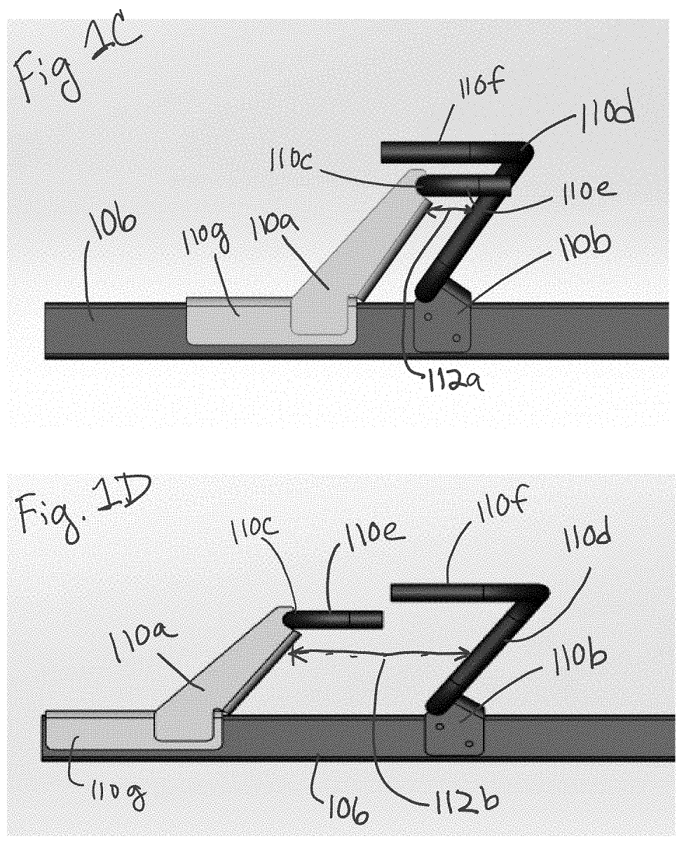

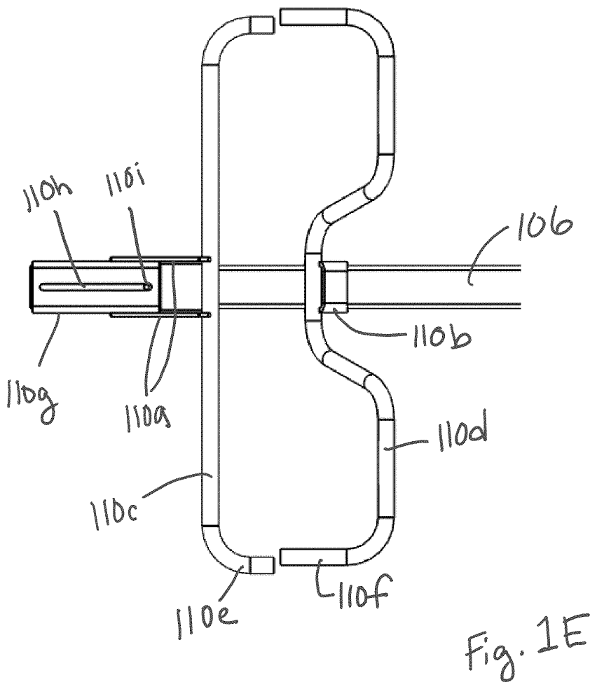

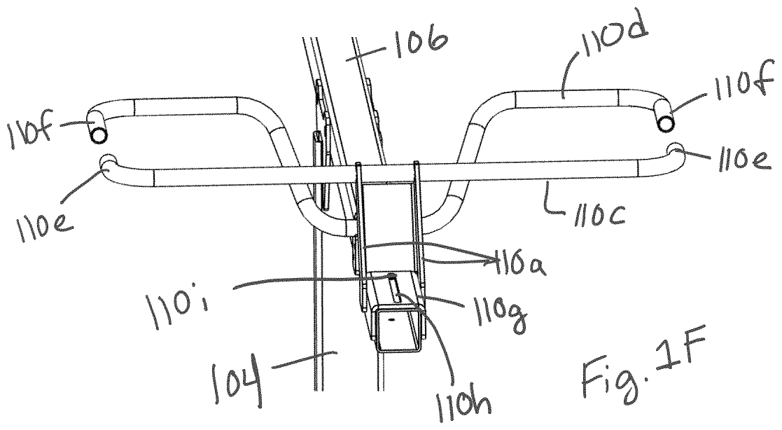

FIG. 1A depicts a known vertical bicycle rack designed to support a bicycle hanging from its front wheel in a cradle 108 above the back wheel. The rack may be provided with a vehicle attachment or receiver hitch tube 101 for inserting into the receiver hitch provided on the rear of a vehicle, or it may utilize some other means of attachment to a vehicle. A vertical member or mast 104 extends upwardly from the vehicle attachment 101. In many examples of a vertical rack 100 a lower horizontal member or crossbar 105 will be provided to engage the rear tires and wheels of bicycles on the rack. Straps or other means of attaching the tires or wheels to the crossbar 105 may be provided. In these vertical racks an upper horizontal member or crossbar 106 is provided to support the front tires and wheels of the bicycles. The upper horizontal member 106 may also be provided with straps to secure the bicycle tires to the crossbar.

In many of the vertical racks one or more non-adjustable tire cradles 108 are provided to receive the front tire and wheel of the bicycle and hold it in a desired orientation. Often the desired orientation is turned at an angle with respect to the bicycle frame to allow closer spacing between the bicycles on the rack 100. In the prior art version shown in FIG. 1 the non-adjustable cradles 108 comprise brackets 108a that attach to the crossbar 106, and fixed tire hoops 108b that receive the tire and wheel of a bicycle. The depicted non-adjustable cradles 108 are formed from bent metal components, but other examples may include plastic or composite materials, or an assembly of plastic, composite, and metal components that together receive the tire or wheel of the bicycle. The common characteristic is that the tire cradles are not adjustable for the size or width of the tire on the bicycle. The distance between the right and left long sides of each tire hoop 108a (or other type of tire cradle as the case may be) is fixed and cannot be changed by a user of the rack.

An embodiment of the inventive adjustable tire cradle 110 is depicted in FIGS. 1B, 1C, and 1D. In these depictions a single embodiment of the adjustable tire cradle 110 is shown on a crossbar 106. In actual use, one or more cradles 110 may be used on a crossbar 106 of a vertical rack just as shown in FIG. 1A. Instead of the non-adjustable hoop or cradle 108b of the prior art, the adjustable cradle 110 allows the long sides 110c and 100d of the tire cradle 110 to be moved closer to or farther away from each other. This allows them to better support bicycle tires of different widths with less chance of damage to the tire or the bicycle wheels or frame. In the depicted embodiment the movement of the tire retention members 110c and 110d is accommodated by movement of one or both of brackets 110a and 110b along the length of crossbar 106. If one bracket is moved closer to the other bracket then the tire retention members 110c and 110d will move closer together, and if the brackets 110a and 110b are moved apart then the tire retention members 110c and 110d move apart as well.

As depicted in FIG. 1B the tire retention members 110c and 11d mainly contact the side walls of the tires 114 or the bicycle wheels along side portions thereof. In some embodiments the tire retention members 110c and 110d may be provided with portions 110e and 110f to engage the tread portions or areas of the bicycle tires to prevent them from rolling out of the tire cradle 110.

In the depicted embodiment the adjustable tire cradle 110 attaches to the crossbar 106 via two separate brackets 110a and 110b, though in other embodiments the adjustable cradle 110 may use a single mounting bracket. In other embodiments without two brackets 110a and 110b, the single bracket may be provided with a slide or pivot mechanism to allow one or both of the tire retention members 110c and 110d to move closer together or farther apart. For example, the members 110c and 110d may be mounted on a scissor mechanism or on an expanding jaw, or one may translate with respect to the other on a sliding arm.

FIGS. 1C and 1D show the adjustable tire cradle 110 configured for two different sizes of bicycle wheels. In FIG. 1C the cradle 110 has been adjusted to receive a narrow bicycle tire such as a road bicycle tire. In the depicted embodiment bracket 110b is fixed to crossbar 106 by rivets or bolts, while bracket 110a is able to translate along crossbar 106. A clamp or latch mechanism (not depicted) is provided to hold the bracket 110a in the desired position on the crossbar 106. The latch mechanism may comprise a retention pin (or threaded bolt) that slides into holes provided in the opposing sides of bracket shoe 110g and through one or more sets of holes 106a in the crossbar 106 at desired positions for certain tire widths. The retention pin is not shown in the figures but will be clear to one of skill in the art. In another version a spring-loaded retention pin may extend outward from crossbar 106 to engage detents or holes in the shoe 110g at desired positions.

FIG. 1C depicts the cradle 110 with the tire retention members 110c and 110d relatively close together along dimension 112a. FIG. 1D depicts the cradle 110 after it has been adjusted to receive a wide tire such as a snow bike tire. The shoe 110g has been slid away from fixed bracket 110b and the distance between tire retention members 110c and 110d has increased as shown by the dimension 112b.

FIGS. 1E and 1F depict a top view and a perspective view, respectively, of an embodiment of the adjustable cradle. In this view of the embodiment a slot 110h is provided in the top of shoe 110g. The slot 110h receives a bolt or clamp at location 110i attached to this embodiment of the crossbar 106 at hole 106a. In this embodiment the shoe 110g slides along crossbar 106 to the limits set by the location of the bolt 110i and the slot 110h. A clamping mechanism such as a lever arm or a nut may be provided on the bolt 110i to secure the shoe 110g in a desired position with respect to base 110b. In other embodiments different adjustment and clamping mechanisms may be used for the movable bracket 110a.

In the depicted embodiment of the adjustable tire cradle 110, the bicycle tire 114 is supported at an angle to the crossbar that is non-perpendicular. This allows the front handlebar of the bicycle to be turned to one side of the bicycle frame while it is carried on the bicycle rack. Turning the front handlebar prevents contact between adjacent bicycles with less intervening space thus allowing more bicycles to fit onto the bicycle rack. In other embodiments of the adjustable tire cradle the tire may be supported in a position that is substantially perpendicular to the crossbar or other support element of the vertical bicycle rack.

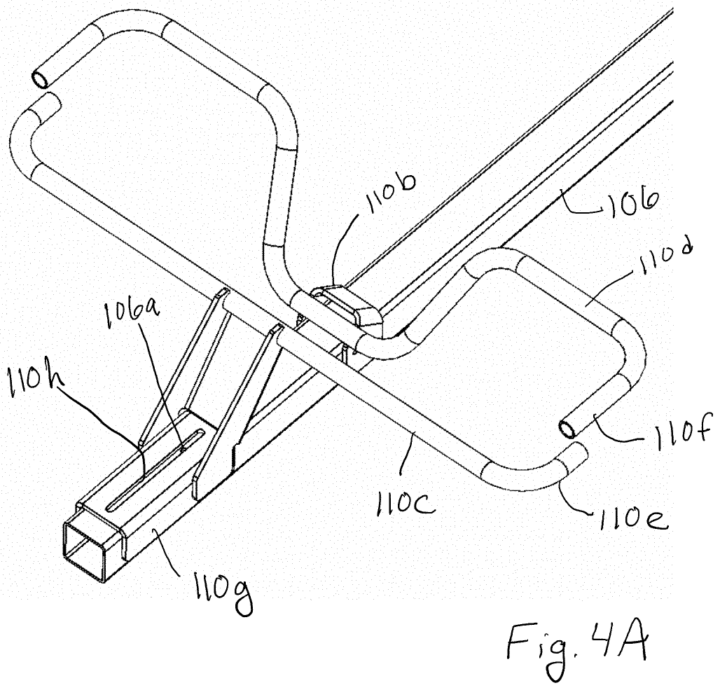

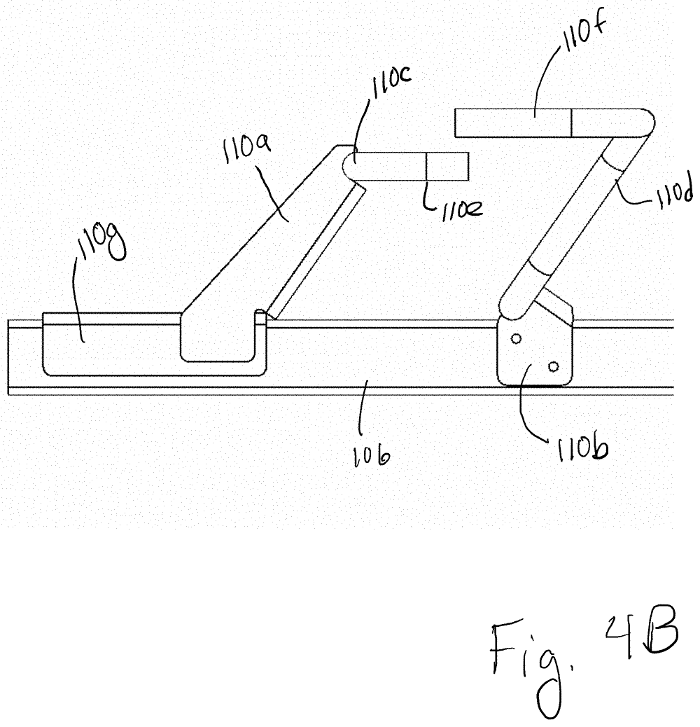

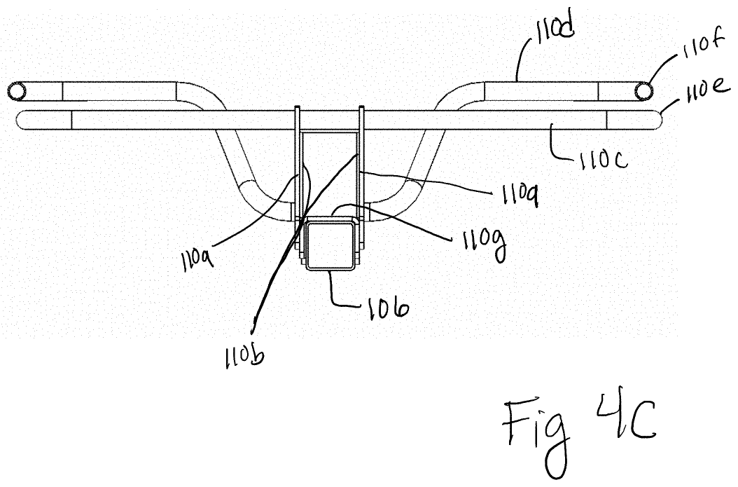

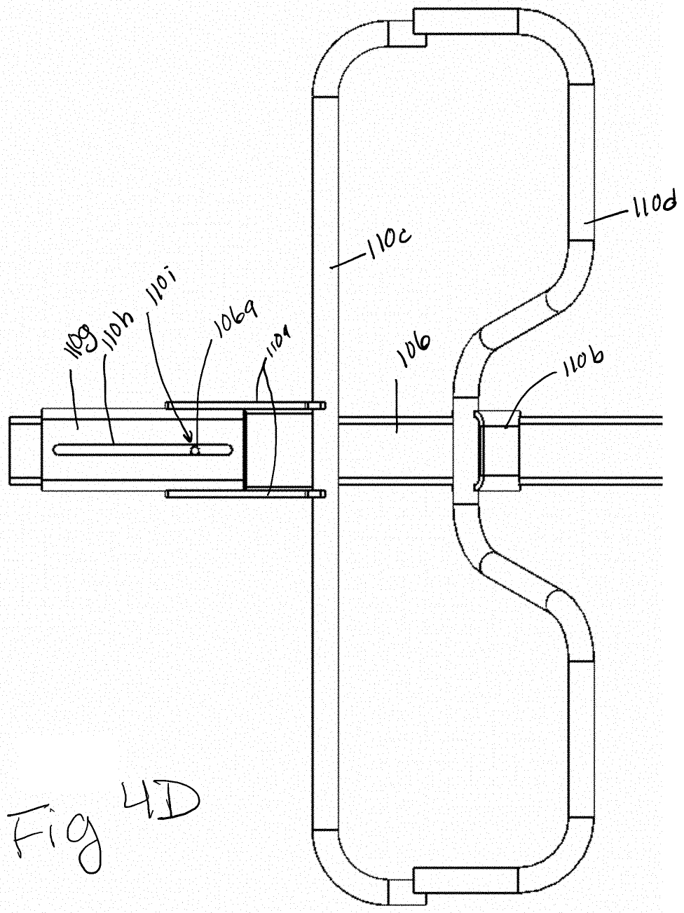

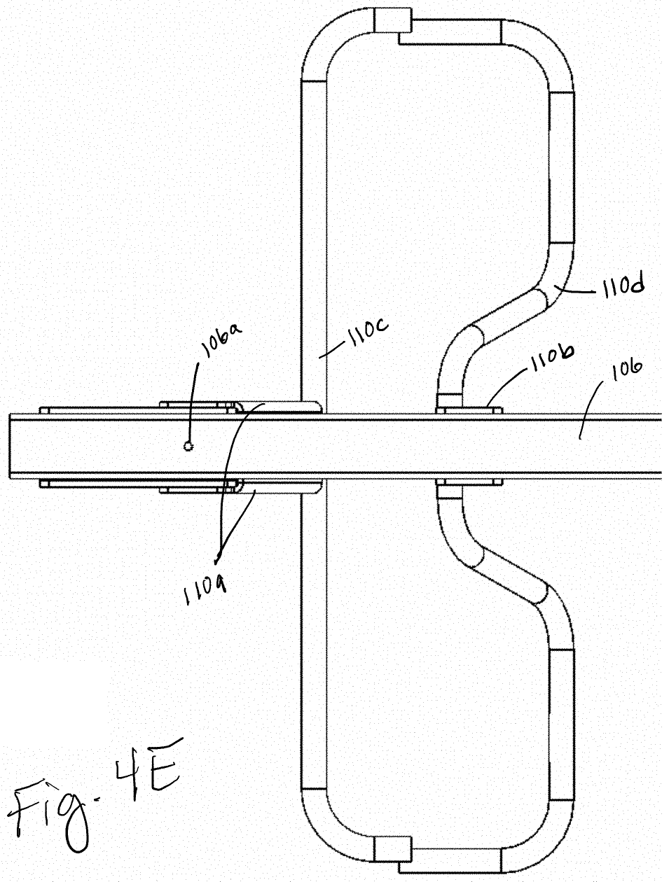

FIGS. 4A, 4B, 4C, 4D, and 4E depict additional views of the embodiment of the inventive bicycle rack shown in FIGS. 1B, 1C, 1D, 1E, and 1F.

Vertical bicycle racks with or without the adjustable tire cradle 110 are typically attached to the rear of a vehicle such as a truck or sport utility vehicle (SUV). The position of the vertical mast 104 prevents a user from opening the tailgate of a truck or the rear access door of an SUV on which the vertical rack has been installed. In prior art racks it has been common to provide a mechanism to pivot the upper part of the bicycle rack away from the vehicle around a pivot point located approximately where the vertical mast 104 connects to the vehicle attachment member 101. Such pivot mechanisms are not optimal because when the rack is loaded with up to 6 bicycles the combined weight of the rack is very heavy making it difficult and dangerous to pivot the rack vertically away from the vehicle. The rack may fall toward the user or may be too heavy for a user to return to the vertical position.

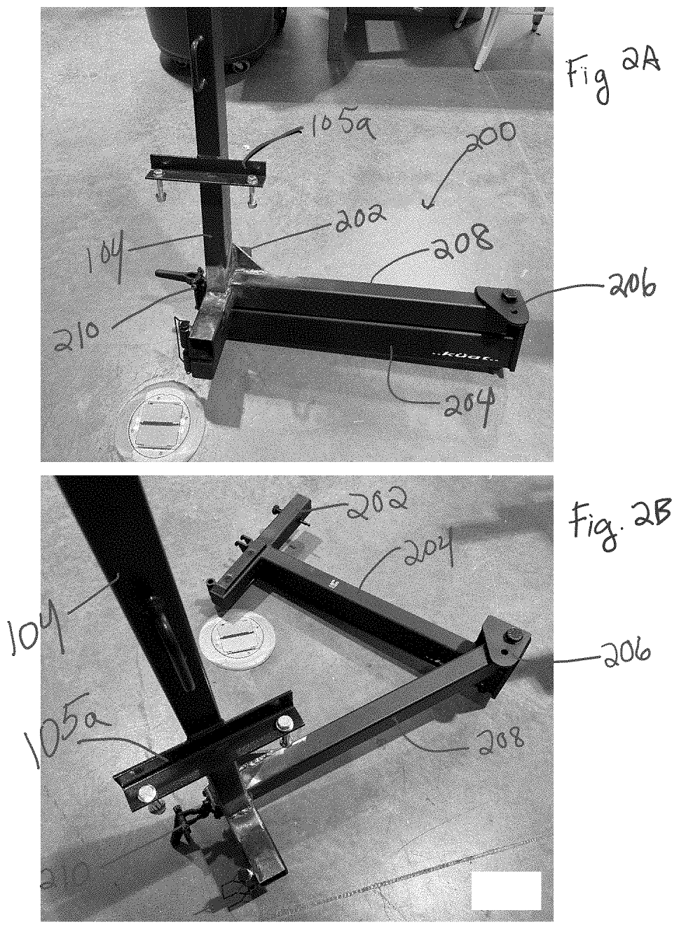

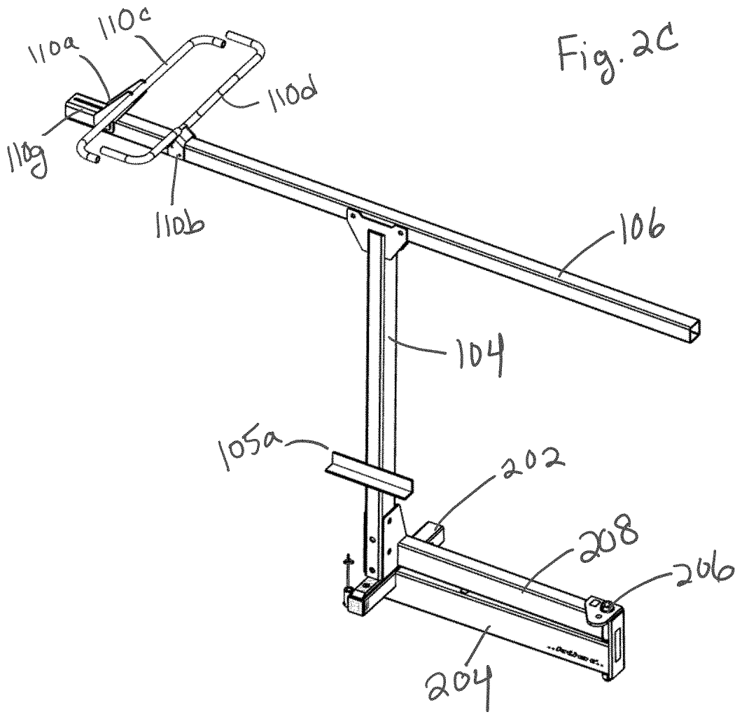

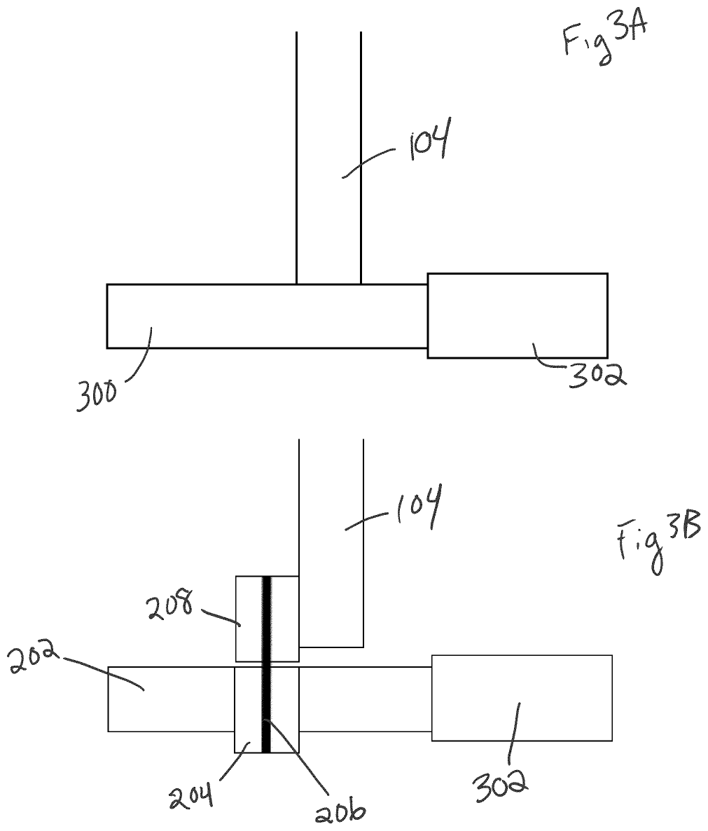

In some embodiments of the inventive bicycle rack, the translation arm shown in FIGS. 2A and 2B is used to translate the vertical mast away from the vehicle without pivoting it in the vertical axis. In these embodiments the rack is provided with a mechanism for translating the bicycle rack in a horizontal direction. In the embodiment depicted in FIGS. 2A and 2B, the vertical mast 104 is attached to a translation mechanism 200 to translate the rack horizontally away from the vehicle attachment member 202 such as a receiver hitch tube. In this embodiment a first member 204 is fixedly attached to the vehicle attachment member 202 and extending substantially perpendicular to the member 202. A hinge 206 is attached to the first member 204 so that a second member 208 may pivot or swing with respect to the first member 204. The vertical mast 104 is attached to the second member 208 so that when member 208 swings the mast 104 and the bicycles on the rack are translated horizontally away from the vehicle attachment member 202 and thus away from the vehicle. A clamp or latch mechanism 210 is preferably provided to lock the second member 208 in the closed position shown in FIG. 2B.

FIG. 2A depicts the translation mechanism in a closed position for when the vehicle it is attached to will be moving. FIG. 2B depicts the translation mechanism in an open position to allow a user to access a truck tailgate or SUV rear access door. In FIGS. 2A, 2B, and 2C, crossbar 105 has been removed from crossbar bracket 105a for clarity. FIG. 2C depicts a perspective view of an embodiment of the inventive bicycle rack with the translation mechanism in a closed configuration.

FIGS. 3A and 3B depict partial schematic views of additional embodiments of the inventive bicycle rack. In the embodiment depicted in FIG. 3A, the rack has a male receiver hitch tube 300 to be inserted into the receiver hitch tube on a vehicle to support the rack. The vertical mast 104 extends upwardly from this tube 300. This embodiment also has a female receiver hitch tube 302 supported by the tube 300. This receiver 302 allows a user to attach a trailer hitch or another receiver hitch accessory to the vehicle.

FIG. 3B depicts a similar embodiment that has a male receiver hitch tube 202 for insertion into the receiver hitch tube on a vehicle. The rack mast 104 is supported on a pivot device with members 204 and 208 connected by hinge 206 as shown in FIGS. 2A and 2B. This embodiment also has a female receiver hitch tube 302 attached to the receiver tube 202 so that a trailer hitch or additional receiver hitch attachments may be attached to the device.

“Substantially” or “about” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, unrecited elements or method steps.

Changes may be made in the above methods, devices and structures without departing from the scope hereof. Many different arrangements of the various components depicted, as well as components not shown, are possible without departing from the spirit and scope of the present invention. Embodiments of the present invention have been described with the intent to be illustrative and exemplary of the invention, rather than restrictive or limiting of the scope thereof. Alternative embodiments will become apparent to those skilled in the art that do not depart from its scope. Specific structural and functional details disclosed herein are not to be interpreted as limiting, but merely as a representative basis for teaching one of skill in the art to employ the present invention in any appropriately detailed structure. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

1. An adjustable tire cradle for a vertical bicycle rack, the vertical bicycle rack having a crossbar, the adjustable tire cradle comprising a first tire retention member and a second tire retention member, both coupled to the crossbar, wherein the second tire retention member is configured to translate on the crossbar with respect to the first tire retention member to allow the adjustable tire cradle to receive varying widths of bicycle tires.

2. The adjustable tire cradle of claim 1, further comprising a first bracket attached to the first tire retention member, the first bracket also attached to the crossbar at a fixed position.

3. The adjustable tire cradle of claim 2, further comprising a second bracket attached to the second tire retention member, the second bracket releasably attached to the crossbar.

4. The adjustable tire cradle of claim 3, wherein the first tire retention member comprises a U-shaped member.

5. The adjustable tire cradle of claim 4, wherein the second tire retention member has at least one side portion extending substantially parallel to a portion of the first tire retention member.

6. The adjustable tire cradle of claim 5 wherein translation of the second tire retention member with respect to the crossbar increases a first distance measured between the second tire retention member and the first tire retention member.

7. The adjustable tire cradle of claim 3 wherein the second bracket is releasably attached to the crossbar by a bolt received in an aperture in the crossbar.

8. An adjustable tire cradle for a bicycle rack, the bicycle rack having a crossbar for supporting a bicycle in a vertical orientation, the adjustable tire cradle comprising:
a first bracket attached to the crossbar at a fixed position;
a second bracket movably attached to the crossbar;
a first tire retention member attached to the first bracket;
a second tire retention member attached to the second bracket; and
a latch mechanism configured to releasably connect the second bracket to the crossbar at a plurality of positions thereon.

9. The adjustable tire cradle of claim 8, wherein the first and second tire retention members each comprise at least one side portion and one tread portion.

10. The adjustable tire cradle of claim 8 wherein the second bracket is configured to move on the crossbar to increase or decrease a distance between the side portions of the first and second tire retention members.

11. The adjustable tire cradle of claim 8 wherein the first tire retention member is U-shaped.

12. The adjustable tire cradle of claim 10 wherein the second tire retention member has two side wall portions and two tread portions.
